(19) United States
(12) Patent Application Publication
(10) Pub. No.: US 2003/0148019 A1
(43) Pub. Date: Aug. 7, 2003

(54) Compositions and methods for forming dielectric layers using a colloid

(76) Inventors: Byung Keun Hwang, Midland, MI (US); Kermit Shannon Kwan, Midland, MI (US); Zhongtao Li, Midland, MI (US); Eric Scott Moyer, Midland, MI (US); Sheng Wang, Midland, MI (US); David Lee Wyman, Mt. Pleasant, MI (US); Xiaobing Zhou, Midland, MI (US)

Correspondence Address: Catherine U. Brown, Dow Corning Corporation, Intellectual Property Dept. - CO1232, P.O. Box 994, Midland, MI, 48686-0994, US

(21) Appl. No.: 09/995,985

(22) Filed: Nov. 19, 2001

(51) Int. Cl. B05D 5/12; B05D 3/02; C04B 14/04

(52) U.S. Cl. 427/58; 427/376.2; 106/491

(57) ABSTRACT

A colloid composition can be used to form a thin film on a substrate. The colloid can be colloidal silica. The thin film can be a dielectric layer. The substrate can be a semiconductor substrate having gaps thereon.

### FIELD OF THE INVENTION

This invention relates to a composition and method for forming thin films. More particularly, this invention relates to a colloid composition that can be used in a method to prepare gap filling thin films.

### BACKGROUND

Integrated circuit technology uses trenches or gaps in semiconductor substrates to isolate circuits. Insulating material is deposited into the gaps to form barrier layers and planarize the topography. Chemical vapor deposition (CVD) and spin-on deposition (SOD) are techniques used to fill gaps on semiconductor substrates to form dielectric layers such as silicon dioxide and silicon dioxide-based layers, see for example, Sawchyn, I., “Integrated Circuits,” Kirk-Othmer Encyclopedia of Chemical Technology, 4^{th} ed., John Wiley & Sons, New York, 1995, Vol. 14, pp. 683-693.

A typical CVD method involves placing a substrate in a reactor chamber where process gases are introduced and heated. This induces a series of chemical reactions that result in the deposition of a desired layer on the substrate. CVD methods can be used to prepare a silicon dioxide film made from, for example, silane or tetraethoxysilane. Various types of CVD processes are known in the art, such as atmospheric pressure CVD, low pressure CVD, or plasma enhanced CVD. However, CVD methods may suffer from the drawback that when gap dimensions approach deep submicron scale, sufficient gap filling becomes difficult.

In a typical SOD method, a solution containing a film-forming material, such as a resin, is deposited on a spinning substrate to form a uniform thin film using certain spin parameters. The spinnability of the solution directly influences the quality and performance of the thin film. After the film-forming material is deposited on the substrate, the film-forming material is cured. However, SOD methods may suffer from the drawback that formation of a uniform film (after cure) with gaps having high aspect ratios is problematic.

### SUMMARY OF THE INVENTION

This invention relates to a colloid composition that can be used to form a thin film on a substrate. This invention further relates to a method that can be used for forming a thin film on a substrate using the colloid composition.

### DETAILED DESCRIPTION OF THE PREFERRED EMBODIMENTS

All amounts, ratios, and percentages are by weight unless otherwise indicated. The following is a list of definitions, as used herein.

### Definitions

“A” and “an” each mean one or more.

“Aspect ratio” means gate height divided by gap width.

“Combination” means two or more items put together by any method.

“Nanoparticles” means primary particle size less than about 100 nanometers.

“Neat colloidal silica” means colloidal silica that is not combined with a film-forming material. Neat colloidal silica may optionally be capped.

“Spinnable” and “spinnability” mean that a composition can be used effectively in an SOD method.

“Substantially inert” means an environment that contains less than about 50 ppm of oxygen. Preferably, a substantially inert environment contains less than about 10 ppm of oxygen.

### Colloid Composition

This invention relates to spinnable colloid compositions, i.e., colloidal solid compositions that can be used in spin-on deposition methods, and methods for the preparation of the colloid compositions. The colloid composition comprises: A) a vehicle comprising an organic solvent, water, or a combination thereof; B) a colloid; optionally C) a surfactant, and optionally D) a stabilizer. The colloid in the compositions can be any colloidal solid, such as silica, alumina, titania, combinations thereof, and others. One skilled in the art would be able to select a suitable colloid without undue experimentation depending on various factors including the desired use of the composition.

Colloidal silica has recently been found to have unique properties that are highly desired for some micro-electronic applications. However, most commercially available colloidal silica is dispersed in an aqueous dispersant and has poor spinnability on common semiconductor substrates including silicon wafers. The invention will be exemplified herein with reference to colloidal silica, however, one skilled in the art should recognize that a colloid other than colloidal silica can be added in addition to, or instead of, all or a portion of the colloidal silica.

### Spinnable Aqueous Colloidal Silica Composition

The composition can be a spinnable aqueous colloidal silica (SACS) composition. The SACS composition comprises a) water, b) a colloidal silica, and c) a surfactant. Ingredients a) and b) can be a commercially available aqueous dispersion of colloidal silica. For example, NALCO® 2327 and NALCO® 1050 are aqueous dispersions of spherical colloidal silica each having a primary particle size of about 20 nanometers. NALCO® 2327 and NALCO® 1050 are commercially available from Nalco Chemical Company of Naperville, Ill., U.S.A. Nalco Chemical Company produces colloidal silicas that are spherical and have primary particle size of about 4 nanometers to about 75 nanometers. Nissan Chemical produces spherical and elongated colloidal silicas having primary particle size of about 10 nanometers to about 30 nanometers. DuPont produces spherical colloidal silica having primary particle size of about 40 nanometers.

The colloidal silica used as ingredient b) can be acidic or basic. The primary particle shape of the colloidal silica is not restricted and can be, for example, spherical, elongated, elliptical, irregular, or combinations thereof. The primary particle size of the colloidal silica depends on various factors including the size of gaps to be filled on the substrate on which the colloidal silica composition will be deposited. The primary particle size can contain at least a portion of nanoparticles to fill nanometer sized gaps. The primary particle size of the nanoparticles can be up to about 40 nanometers, alternatively up to about 30 nanometers, alternatively up to about 20 nanometers, alternatively up to about 15 nanometers. The primary particle size of the nanoparticles can be at least about 5 nanometers, alternatively at least about 10 nanometers. The primary particle size distribution can be mono-modal or multi-modal.

The colloidal silica may optionally be surface treated or ‘capped’ with organic groups in a process known as ‘capping’. Suitable organic groups include trialkylsilyl groups such as trimethylsilyl groups. Capping processes are known in the art, see for example, U.S. Pat. No. 6,051,672. Some capping processes may render the surface of the colloidal particles relatively unreactive, e.g., by replacing some or substantially all of the hydroxyl groups on the surface of the particle with unreactive organic groups.

The surfactant can be added by any convenient means, e.g., by mixing under ambient conditions. Any surfactant that lowers surface tension of the composition below that of the substrate to which the composition can be applied can be used. The surfactant should improve wetting without adversely affecting the colloidal stability. Surface tension of the SACS composition can be up to about 70 milliNewtons/meter (mN/m) at 25° C., alternatively up to 50 mN/m. Surface tension of the SACS composition can be at least about 20 mN/m at 25° C.

The amount of surfactant depends on various factors including the particle size and shape of the colloidal silica. The amount of surfactant can be at least about 0.1%. The amount of surfactant can be up to 10%.

Various surfactants, such as a nonionic surfactant, an anionic surfactant, a cationic surfactant, an amphiphilic surfactant, or a combination thereof can be used in the invention. Surfactants are known in the art and commercially available, see for example, McCutcheon's Volume 1: Emulsifiers & Detergents, North American Edition, (2001); and J. W. McCutcheon, “Synthetic Detergents,” MacNair-Dorland Company, New York. Examples of surfactants include the alkylene oxide condensates of long chain alcohols, alkali metal and ammonium salts of long chain alkyl sulfates, a combination thereof, and others.

In addition to, or instead of, a surfactant, a water miscible organic solvent or a combination of an organic solvent and a surfactant can be used. Examples of such organic solvents include alcohols, glycol ethers, dimethyl ether, ketones, acetone, and poly(vinyl pyrollidone)-derivatives, alternatively alcohols such as butanol, isopropanol, ethanol, ethoxy- and methoxy ethanols, and a combination thereof.

The type of surfactant chosen depends on various factors including the type and amount of colloidal silica in the SACS composition. Nonionic surfactants provide the advantage that little or no ionic contaminants will be incorporated into the composition from their use. Examples of some of nonionic surfactants are siloxane surfactants such as DOW CORNING® Q2-5211 commercially available from Dow Corning Corporation of Midland, Mich. or organofunctional trisiloxanes such as heptamethyl-(propyl(poly(ethylene oxide))hydroxy) trisiloxane; phenols, acetylenic diols such as SURFYNOL® 61 and other SURFYNOL® surfactants; alcohols such as ethanol; ethylene glycol; SYNTHRAPOL®-AB; a combination thereof, and others.

A stabilizer may optionally be added to the SACS composition. The SACS composition can comprise at least about 0.1% stabilizer. The composition can comprise up to about 1% stabilizer. Stabilizers are known in the art and commercially available. The stabilizer can be an inorganic base, for example, ammonium hydroxide. The stabilizer can be an organic base, such as aminoethanol, diethyl amine, triethyl amine, a combination thereof, and others.

### Spinnable Organic Solvent Containing Colloidal Silica Composition

The composition can be a spinnable organic solvent containing colloidal silica (SOSCCS) composition comprising a) an organic solvent and b) colloidal silica. The organic solvent has a relatively low surface tension, e.g., lower than the surface tension of water. The organic solvent is selected such that the surface tension of the SOSCCS composition is lower than that of a substrate to which the SOSCCS composition can be applied. The surface tension of the SOSCCS composition can be up to about 70 milliNewtons/meter (mN/m) at 25° C., alternatively up to 50 mN/m. Surface tension can be at least about 20 mN/m at 25° C.

The organic solvent has volatility as measured by boiling point at ambient pressure. Boiling point at ambient pressure can be up to about 300° C., alternatively up to about 200° C., alternatively up to about 150° C. Boiling point at ambient pressure can be at least about 30° C. The organic solvent can be at least somewhat miscible with water. The organic solvent should not cause gelation to colloidal silica.

Suitable organic solvents include mono alkylated glycols, water miscible alcohols such as ethanol and 2-ethoxyethanol, ketones such as methyl isobutyl ketone (MIBK), a combination thereof, and others. One skilled in the art would recognize that some organic solvents can be used in addition to, or instead of, a surfactant.

When the organic solvent is a protic organic solvent, the colloidal silica can be capped or uncapped. When the colloidal silica is capped, the organic solvent is not restricted. Capping allows the colloidal silica to be dispersed in some organic solvents that have relatively limited miscibility with water as compared to protic organic solvents. The resulting capped colloidal silica composition can have improved gap-filling capability and can form thin films of improved performance in some circumstances.

The colloidal silica in the SOSCCS composition can be neat colloidal silica. Neat colloidal silica may optionally be capped. The source of colloidal silica is not restricted. The colloidal silica can be obtained from commercial sources of colloidal silica dispersed in aqueous dispersants, such as those described above.

The SOSCCS composition can be prepared by solvent transfer of an aqueous dispersion of colloidal silica to an organic solvent. The organic solvent can be combined with an aqueous dispersion of colloidal silica, e.g., by mixing. An amount of water is removed from the resulting combination. The amount of water removed is sufficient to provide the combination with a desired solid content. The desired solid content will depend on various factors including the specific colloidal silica and organic solvent chosen. The solid content can be at least about 5%, alternatively at least about 10%. The solid content can be up to about 40%, alternatively up to about 15%. The method by which water is removed depends on various factors including the stability of the colloidal silica in the organic solvent. For example, the water can be removed by stripping under vacuum using, for example, a rotary evaporation device. Alternatively, water can also be removed in a distillation under either atmospheric or reduced pressure. This method is applicable to both acidic and basic colloidal silica.

The exact amounts of organic solvent and colloidal silica depend on various factors including the specific organic solvent and colloidal silica used and the amount of residual water that may be left in the SOSCCS composition when an aqueous dispersion of colloidal silica is used. The amounts can be selected such that the combination of organic solvent and any water remaining in the SOSCCS composition will provide the SOSCCS composition with a surface tension as described above.

The SOSCCS composition can comprise a) an organic solvent, b) a colloidal silica, and e) water. The amount of organic solvent can be at least about 79%. The amount of organic solvent can be up to about 90%. The amount of colloidal silica can be at least about 5%, alternatively at least about 10%. The amount of colloidal silica can be up to 20%, alternatively up to about 15%. The amount of water can be at least about 1%. The amount of water can be up to about 10%.

The SOSCCS may optionally further comprise a surfactant, as described above.

The SOSCCS composition may optionally further comprise a stabilizer that prevents gelation of the colloidal silica. The stabilizer can be an inorganic base, for example, ammonium hydroxide. The stabilizer can be an organic base, such as aminoethanol, diethyl amine, triethyl amine, a combination thereof, and others. The SOSCCS composition can comprise at least about 0.1% stabilizer. The SOSCCS composition can comprise up to about 1% stabilizer. Stabilizers are known in the art and commercially available.

### Method of Making a Film

This invention further relates to a method for making a film using the composition described above. The method comprises:

i) applying a composition described above to a substrate, and

ii) curing the composition.

The substrate can be a semiconductor substrate. The semiconductor substrate can have gaps thereon. The semiconductor substrate is not specifically restricted, and can be any semiconductor substrate used in the manufacture of an integrated circuit. For example, the substrate may be a silicon wafer having gates thereon.

The composition can be applied by various methods including spin-on depositing, dip-coating, spray-coating, flow-coating, screen-printing, stencil-printing, and others. When spin-on deposition will be used in step i), the conditions will depend on various factors including the desired thickness of the film formed by the method, the specific composition selected, and others. In one embodiment of the invention, a semiconductor substrate onto which the composition is deposited is spun at a speed of at least about 500 revolutions per minute (rpm). The speed can be up to about 6,000 rpm. Time for deposition can be at least about 5 seconds. Time for deposition can be up to about 3 minutes, alternatively up to about 60 seconds. The composition can be deposited in an amount of up to about 0.4 milliliters/square centimeter. However, the spin speed, spin time, and amount of composition can be adjusted to produce a film having a desired thickness, e.g., the desired thickness can be up to about 800 nanometers.

In one embodiment of the invention, the method further comprises the optional step of removing all or a portion of the vehicle after SOD and before cure. The vehicle may be removed by any convenient means, such as heating under ambient or reduced pressure. The vehicle may be removed by heating to a temperature of at least about 250° C. The vehicle, may be removed by heating to a temperature of up to about 400° C., alternatively up to about 350° C.

Curing the composition can be carried out by any conventional means. For example, curing can be carried out by heating the product of step i) to a temperature at which the colloid will consolidate. Curing can be carried out by heating the product of step i) to a temperature of at least about 400° C. Curing can be carried out by heating the product of step i) to a temperature of up to about 1200° C., alternatively up to about 800° C., alternatively up to about 700° C. Cure time can be at least about 30 minutes. Cure time can be up to about 2 hours. Curing can be carried out under substantially inert or oxidative conditions. Curing can be carried out by heating the product of step i) under substantially inert conditions, e.g., where the atmosphere comprises primarily nitrogen. Alternatively, curing can be carried out by heating the product of step i) under oxidative conditions, e.g., where the atmosphere comprises oxygen or water vapor, or both.

The method may further comprise: iii) forming a secondary coating on top of the product of step ii). The product of step ii) is referred to as a primary coating. In this embodiment, the secondary coating can be formed by repeating steps i) and ii), by spin-on deposition of a film-forming material solution and cure of the film-forming material solution, or by a CVD process, as described above.

Repeating steps i) and ii) in step iii) produces a film with uniform chemical composition and mechanical properties. If a film-forming material or CVD material is used in step iii), the film produced by the method comprises layers having different chemical compositions and mechanical properties. The thickness of the secondary coating can be adjusted by changing various parameters such as spin speed and solid content of the resin or colloid compositions for spin-on deposition or deposition rate for CVD materials.

The method can produce substantially crack free films of at least about 800 nanometers in thickness. The method can produce films having good mechanical strength. The method can produce films having a dielectric constant of up to about 4, alternatively up to about 2. The method can produce films comprising silicon and oxygen in amounts such that a molar ratio of silicon to oxygen is about 1 to about 2. The method can produce films having good etch resistance in gaps. For example, some films can be prepared having etch resistance in gaps of up to about 100 angstroms per minute, alternatively up to about 70 angstroms per minute when exposed to a solution of 200:1 water:HF at room temperature. The method can produce films having good etch selectivity during processes to make electronic devices.

### Methods of Use

The composition and method described above can be used to form film used as a dielectric layer in a wide variety of applications. The composition and method can be used to form a pre-metal dielectric (PMD) layer, an inter-layer dielectric (ILD) layer, and a planarizing layer in an electronic device. The method of the invention is illustrated in the formation of a pre-metal dielectric (PMD) layer in a dynamic random access memory (DRAM) device.

In a typical process to make a DRAM device, a silicon wafer is provided with a plurality of ceramic gates thereon. The gates have gaps therebetween. Aspect ratio can be at least about 1, alternatively at least about 8. Aspect ratio can be up to about 10. Gaps can have widths of at least about 10 nanometers, alternatively at least about 40 nanometers, alternatively at least about 50 nanometers, alternatively at least about 70 nanometers. Gaps can have widths of up to about 1000 nanometers, alternatively up to about 500 nanometers, alternatively up to about 300 nanometers. The method described above can be used. For example, a composition is deposited in the gaps, and the composition is cured, e.g., by heating the resulting coated wafer under substantially inert conditions. A primary coating can be deposited such that the primary coating has a thickness about equal to the gate height, i.e., the primary coating is about level with the top of the gates. Thereafter, a secondary coating is formed on top of the primary coating, i.e., extending above the tops of the gates. Total thickness of the resulting PMD layer comprising the primary coating and the secondary coating can be controlled by varying the thickness of the secondary coating.

One skilled in the art would recognize that the method described above can be used in other devices in addition to DRAM devices. The method described above can be used to form dielectric layer in a LOGIC device or a memory device such as a DRAM or static random access memory (SRAM). The method can be used to form dielectric layers in a central processing unit (CPU) device. A CPU can have at least ten, alternatively at least twelve dielectric layers.

DRAM devices, and other electronic devices during the fabrication of which this invention can be used, are known in the art, see for example EP 0 097 789 A2, EP 0 928 020 A2, and U.S. Pat. No. 6,214,698 B1.

The method can also be used for trench islolation such as shallow trench isolation (STI) in, for example, LOGIC and memory devices. The method can be used to fill a trench or hole on a semiconductor substrate to isolate p- and n-junctions and prevent migration of dopants, see for example, EP 0 097 789 A2 and Skinner, R. D., ed., Basic Integrated Circuit Technology Reference Manual, Integrated Circuit Engineering Corporation, 1993, pp. 1-6 to 1-10. One skilled in the art would recognize that the method described above can be used in any application where gap filling is desirable and that the use of the invention is not restricted.

### EXAMPLES

These examples are intended to illustrate the invention to one skilled in the art and should not be interpreted as limiting the scope of the invention set forth in the claims.

### Example 1

### Preparation of Spinnable Colloidal Silica Compositions

NALCO® 2327, an aqueous silica colloid is made spinnable by a solvent transfer to 2-ethoxyethanol. Another aqueous silica colloid, NALCO® 1050, has been redispersed in methyl isobutyl ketone (MIBK) after a surface treatment with chlorotrimethylsilane.

### Example 2

### Thin Film Preparation

The two spinnable colloidal silica samples of Example 1 are used to prepare thin films for a pre-metal dielectric application (PMD). Both samples have superior gap-filling capability.

### Example 3

### PMD Layer Formation Using a Spinnable Organic Solvent Based Colloidal Silica Composition

A colloidal silica composition containing 10% colloidal silica having an average particle diameter of 15 nanometers is deposited on a patterned silicon wafer by spin-on deposition. The spin speed is 2000 rpm. The resulting coated wafer is heated to 700° C. in a nitrogen environment for 30 minutes to cure the colloidal silica composition. An 8000 Angstrom thick silicon dioxide film forms. Good gap filling and HF etching survivability are observed for the silicon dioxide film in the 80 (aspect ratio 8), 500, and 1000 nanometer trenches in a scanning electron microscope (SEM) analysis.

### Example 4

### PMD Layer Formation Using a Spinnable Aqueous Colloidal Silica Composition

An aqueous colloidal silica composition containing 10% colloidal silica having an average particle diameter of 20 nanometers and 1% Q2-5211 is deposited on a patterned silicon wafer by spin-on deposition. The spin speed is 2000 rpm. The resulting coated wafer is heated to 700° C. in an oxidative environment for 30 minutes to cure the colloidal silica composition. An 8000 Angstrom thick silicon dioxide film forms. Good gap filling and HF etching survivability are observed for the silicon dioxide film in the 80 (aspect ratio 8), 500, and 1000 nanometer trenches in a SEM analysis.

### Comparative Example 1

### PMD Layer Formation Using a Resin Solution

A spin-on resin solution containing 14% solid content is deposited on a patterned silicon wafer by spin-on deposition. The spin speed is 2000 rpm. The resulting coated wafer is heated to 700° C. in an oxidative environment for 30 minutes to cure the resin film. An 8000 Angstrom thick silicon dioxide film forms. During dipping in 200:1 water:HF solution for 90 seconds, film is either completely or partially etched away in the 80 (aspect ratio 8), 500, and 1000 nanometer trenches in a SEM analysis.

### Comparative Example 2

### PMD Layer Formation Using a Solution with a Blend of Colloidal Silica and Resin

A spinnable colloidal silica containing 10 weight % solid is mechanically blended with the same amount of a 14% spin-on resin solution. The blend is then deposited on a patterned silicon wafer by spin-on deposition. The spin speed is 2000 rpm. The resulting coated wafer is heated to 700° C. in an oxidative environment for 30 minutes to cure the resin film. An 8000 Angstrom thick silicon dioxide film forms. During dipping in 200:1 water:HF solution for 90 seconds, film is either completely or partially etched away in the 80 (aspect ratio 8), 500, and 1000 nanometer trenches in a scanning electron microscope (SEM) analysis.

We claim:

1. A method comprising:
i) depositing a composition on a substrate having a gap thereon, wherein the composition fills the gap and wherein the composition comprises
a) a colloid,
b) a vehicle comprising an organic solvent, water, or a combination thereof,
with the proviso that when ingredient b) does not comprise an organic solvent, then the composition further comprises c) a surfactant, and optionally d) a stabilizer; and
ii) curing the composition.

2. The method of claim 1, wherein the colloid comprises colloidal silica.

3. The method of claim 2, wherein the colloidal silica comprises capped colloidal silica.

4. The method of claim 1, wherein the organic solvent is a protic organic solvent.

5. The method of claim 1, wherein the organic solvent is at least partially miscible with water.

6. The method of claim 1, wherein the substrate has a plurality of gaps thereon.

7. The method of claim 6, wherein the substrate is a semiconductor substrate having a plurality of ceramic gates thereon.

8. The method of claim 1, wherein step i) is carried out by spin-on depositing, dip-coating, spray-coating, flow-coating, screen-printing, or stencil-printing.

9. The method of claim 1, wherein step ii) is carried out by heating the product of step i) under substantially inert conditions.

10. The method of claim 1, wherein step ii) is carried out by heating the product of step i) under oxidative conditions.

11. The method of claim 1, further comprising removing organic solvent, water, or both, from the product of step i) before step ii).

12. The method of claim 1, further comprising:
iii) forming a secondary coating on top of the product of step ii).

13. The method of claim 12, wherein step iii) is carried out by a method comprising repeating steps i) and ii), spin-on deposition of a film-forming material solution and cure of the film-forming material solution, or a chemical vapor deposition method.

14. The method of claim 7, further comprising:
iii) forming a secondary coating on top of the product of step ii).

15. The method of claim 14, wherein the product of step ii) is a primary coating having a thickness about equal to height of the gates.

16. The method of claim 1, wherein the method is used to form a layer comprising a premetal dielectric layer or a shallow trench islolation layer.

17. The method of claim 16, wherein the method is used to make an electronic device comprising a LOGIC or memory device.

18. A method comprising:
i) depositing a composition on a substrate, wherein the compostion comprises
a) a capped colloidal silica,
b) an organic solvent,
optionally c) a surfactant,
optionally d) a stabilizer, and
optionally e) water; and
ii) curing the composition.

19. The method of claim 18, wherein the organic solvent is a protic organic solvent.

20. The method of claim 18, wherein the organic solvent is at least partially miscible with water.

21. The method of claim 18, wherein step i) is carried out by spin-on depositing, dip-coating, spray-coating, flow-coating, screen-printing, or stencil-printing.

22. The method of claim 18, wherein step ii) is carried out by heating the product of step i) under substantially inert conditions.

23. The method of claim 18, wherein step ii) is carried out by heating the product of step i) under oxidative conditions.

24. The method of claim 18, further comprising removing organic solvent, water, or both, from the product of step i) before step ii).

25. The method of claim 18, wherein the method is used to form a layer comprising a premetal dielectric layer, an interlayer dielectric layer, a planarizing layer, or a shallow trench islolation layer.

26. The method of claim 25, wherein the method is used to make an electronic device comprising a LOGIC or memory device.

27. A composition comprising:
a) a capped colloidal silica,
b) an organic solvent,
optionally c) a surfactant,
optionally d) a stabilizer, and
optionally e) water;
with the proviso that
the composition has a composition surface tension less than a substrate surface tension of a substrate to which the composition will be applied.

28. The composition of claim 27, where
A) the composition surface tension is at least about 20 milliNewtons/meter, and
B) the composition surface tension is up to about 70 milliNewtons/meter.

29. The composition of claim 27, where
1) component a) is present in an amount of at least about 5%, and
2) component a) is present in an amount of up to about 20%.

30. The composition of claim 27, where
1) component b) is present in an amount of at least about 79%, and
2) component b) is present in an amount of up to about 90%.

31. The composition of claim 27, where
1) component c) is present in an amount of at least about 0.1%, and
2) component c) is present in an amount of up to about 1%.

32. The composition of claim 27, where
1) component d) is present in an amount of at least about 0.1%, and
2) component d) is present in an amount of up to about 1%.

33. The composition of claim 27, where
1) component e) is present in an amount of at least about 1%, and
2) component e) is present in an amount of up to about 10%.

34. The composition of claim 27, where component b) comprises 2-ethoxyethanol, methyl isobutyl ketone, or a combination thereof.

35. The composition of claim 27, wherein component c) comprises a nonionic surfactant.

36. The composition of claim 35, wherein the nonionic surfactant comprises heptamethyl(propyl(poly(ethylene oxide))hydroxy) trisiloxane.

37. The composition of claim 27, wherein component d) comprises an inorganic base, an organic base, or a combination thereof.
